(19) United States
(12) Patent Application Publication
(10) Pub. No.: US 2020/0017752 A1
(43) Pub. Date: Jan. 16, 2020

(54) Use Of A Composition Containing At Least One Biodegradable Sugar-Amide-Compound In Combination With At Least One Sulfur-Based Synergist For Corrosion Inhibition Of A Metallic Equipment In Oilfield Applications

(71) Applicant: Clariant International Ltd., Muttenz 1 (CH)

(72) Inventors: Jonathan WYLDE, The Woodlands, TX (US); Nihal U. OBEYESEKERE, Houston, TX (US); Thenuka ARIYARATNA, The Woodlands, TX (US); Dirk LEINWEBER, Kelkheim (DE); Franz-Xaver SCHERL, Burgkirchen (DE)

(73) Assignee: Clariant International Ltd., Muttenz 1 (CH)

(21) Appl. No.: 16/465,552

(22) PCT Filed: Sep. 18, 2017
(86) PCT No.: PCT/EP2017/073398

§ 371 Date: May 30, 2019

Related U.S. Application Data
(63) Continuation of application No. 15/366,301, filed on Dec. 1, 2016, now abandoned.

(30) Foreign Application Priority Data
Dec. 15, 2016 (EP) 16204300.4

(51) Int. Cl. C09K 8/54; C23F 11/04; C09K 8/035

(52) U.S. Cl. CPC C09K 8/54; C09K 2208/32; C09K 8/035; C23F 11/04

(57) ABSTRACT

In this invention the use of glucamides in combination with at least one sulfur-based synergist chosen from the group of thiols, thioethers, thiosulfates, thioglycolic acids, thiourea or derivatives thereof in a formulation for corrosion inhibition in the gas and oil industry is described.

The present invention relates to an improved method for corrosion control as well as an improved composition for use as corrosion inhibitor. More particularly, the present invention relates to a sugar-based surfactant in combination with at least one sulfur-based synergist for enhanced corrosion protection for application during crude oil production from subterranean formations.

Corrosion is a serious and challenging problem in the oil and gas industry and its prevention is acute in offshore operations. Water, acidic gases (such as hydrogen sulfide and carbon dioxide), organic acids, and oxygen contribute to the corrosion of mild steel, and other types of alloys used in the oil and gas industry. Corrosion can cause oil and gas to leak from flowlines which can lead to explosions, accidents, and environmental disasters. Corrosion inhibitors are essential for preventing uncontrolled discharge of oil and/or gas into the environments surrounding the flowlines.

Corrosion inhibitors are either water-soluble or oil-soluble chemical compounds. When added in small quantities to an aggressive medium, these chemicals inhibit corrosion by changing the surface conditions of the metal. Factors like CO₂, H₂S, S, polysulfides, organic acids, composition of liquids, flow conditions, inorganic anions, such as chlorides, oxygen, pressure and temperature have an influence on the corrosion rate.

Amine containing compounds have long been known as film-forming corrosion inhibitors (see: Production of Chemicals for the Oil and Gas Industry, Malcolm A. Kelland, 2009, CRC Press Taylor & Francis Group).

WO-92/06073 discloses processes for making surfactants from fatty acids or their derivatives in combination with N-alkylglucamines, the latter made by reductive amination of glucose. Glucose reductive amination processes are more fully disclosed in U.S. Pat. No. 2,016,962.

U.S. Pat. No. 1,985,424 discloses the manufacturing of surfactants by reacting the product of heating glucose and aqueous methylamine in the presence of hydrogen and a hydrogenating catalyst under pressure with an organic carboxylic acid such as stearic acid or oleic acid. The condensation product, prepared at about 160° C., is said to be predominantly a secondary amide.

In the prior art, the substances including sugar based 1-Deoxy-1-N-octylamino-D-glucitol are known to have surfactant effects. The substance is for instance disclosed in Journal of Surfactants and Detergents, Volume 7, No 2, pages 147-159 and pages 161-167.

U.S. Pat. No. 2,993,887 discloses glucamide structures and their synthesis.

Environ. Sci. Technol. 1996, 30, 2143-2147 and Langmuir 1996, 12, 588-590 discloses glucamide surfactants forming microemulsion systems between water and chlorocarbons.

U.S. Pat. No. 5,725,470 discloses the use of glucamides in processes for soil remediation.

WO-96/28458 discloses a sugar based compound like Deoxy-1-N-octylamino-D-glucitol as biocide for instance within industrial applications.

CA-2162459 discloses the use of glucamides with other components such as alkyl polyglycosides as corrosion inhibitors for silver when used in dishwashing detergent applications.

WO-96/33953 teaches the use of a stain corrosion and scale inhibitors for laundry applications where N-methyl D-glucamine is reacted with other components to form novel products to provide stain removal while protecting the metallic surfaces of washing machine internals.

U.S. Pat. No. 3,063,790 describes the use of N-methyl D-glucamine as a corrosion inhibitor for use in the oilfield applications and in particular for water soluble corrosion inhibition.

U.S. Pat. No. 4,549,882 generically describes the use of glucamine derivatives for application in alcohol containing fuels for preventing corrosion of internal combustion engines.

DE-102014003367 describes the use of N-Methyl-N-Acyl glucamines as corrosion inhibitor in metal working operations in which also the use of sulphonates and/or sulphates is described of which the latter are being used as emulsifiers.

The next set of patents is based around the use of sulfur-containing compounds as corrosion inhibitors.

U.S. Pat. No. 4,536,302 discusses the use of sulfur compounds where the oxidation state is either 0 or >0. Thiocyanate or thio amide is used at concentrations as high as 1 g/L. Furthermore, the reference discloses the addition of a reducing sugar (mono-saccharide, disaccharide or oligosaccharides) such as glucose, fructose, lactose, etc. These sugars are added at even higher rates of 2 to 10 μg/L.

U.S. Pat. No. 4,728,446 describes a corrosion inhibitor composition containing an alkali or alkaline-earth metal halide in water, zinc ions and thiocyanate ions.

U.S. Pat. Nos. 4,784,778 and 4,784,779 disclose the use of 2-mercaptoethanol, sodium, ammonia and/or calcium thiocyanate, with or without the addition of aldose based antioxidants such as arabinose, ascorbic acid, isoascorbic acid, gluconic acid etc. Ammonium thioglycolate is also mentioned as an additional component. It is noteworthy that very high concentration of inhibitor is required in the experimental data.

U.S. Pat. No. 4,980,074 discloses the corrosion inhibitor as a blend of soluble aliphatic or aromatic aldehydes with or without olefinic unsaturation in combination with an alkali metal, thiocyanates or ammonium thiocyanates.

EP-0139260 discusses phosphorus containing compounds and the use of phosphonium salts such as triphenylphosphine. This is in combination with thiocyanate as well as a commercial product being added called “TRETOLITE™ KI-86”. “TRETOLITE™ KI-86” is disclosed as a Mannich amine-based formulation.

In general, the mechanism for sulfur containing compounds is one of passivating layer formation and is a very effective means of corrosion control. However, there is an increased risk of stress corrosion cracking, and several failures in the industry have been attributed to the reliance of sulfur containing compounds alone as means of effective corrosion control.

The intention of the current invention is to deliver new corrosion inhibitors that lower the corrosion rates to as low as possible levels in oilfield fluids. It is further an object of the present invention to provide higher corrosion inhibiting performance than the existing art. It is further, an object of the present invention to be applicable and compatible in all oil industry brine types including low and high salinity and hardness which is often not specifically mentioned in the art. It is further an object of the current invention to provide corrosion protection particularly at high temperature (150° C.), as well as low temperature performance, due to the trend to drill deeper, hotter, higher pressure wells. It is still further an objective of the present invention to overcome the disadvantage of prior art technologies that are either/or non-sustainably sourced, toxic, poorly biodegradable, and bio-accumulating and acceptable for use in even the most environmentally sensitive areas of the world.

In a first aspect, the invention relates to the use of a composition in corrosion inhibition, the composition comprising

a) at least one compound according to formula (1)

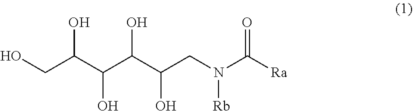

wherein
Ra is a C₅ to C₂₉ linear, branched, saturated or unsaturated aliphatic hydrocarbon group,
Rb is a C₁ to C₂₃ linear, branched, saturated or unsaturated aliphatic hydrocarbon group,
   or a compound obtainable from formula 1 by eliminating one mole of water from the polyhydroxy group, thereby forming a cyclic ether, and
   b) at least one sulfur synergist selected from the group consisting of
   b1) a compound according to formula (5)

R¹—S—R² (5)
wherein
R¹ and R² are independently hydrogen, C₁ to C₁₈ alkyl, C₂ to C₁₈ alkenyl or a C₇ to C₁₈ alkyl aromatic group, and wherein R¹ and R² may contain oxygen or nitrogen atoms, or may be substituted with a carboxylic acid group or an amide group, with the proviso that R¹ and R² are not both hydrogen
b2) a metal or ammonium thiosulfate salt, and
b3) a compound according to formula (6)

S=C(NHR⁵)(NHR⁶) (6)
wherein
R⁵ and/or R⁶ are independently H, C₁ to C₁₀ alkyl, C₂ to C₁₀ alkenyl,
C₅ to C₉ aryl groups or mixtures thereof.

The use of the composition of the first aspect is as a corrosion inhibitor formulation for metal. Such use is preferably performed during the production and/or processing of crude oil and natural gas, particularly in the presence of sweet gas.

In a second aspect of the invention there is provided a process for inhibiting corrosion of metal, the process comprising bringing the metal into contact with the composition as described in the first aspect. The process is preferably applied to metal which is in contact with sweet gas during crude oil or natural gas production or processing in an aqueous medium.

The preferred embodiments as described below will be applicable to all aspects of this invention.

The first component of the instant invention may be a compound of formula 1 or a product obtained therefrom by elimination of one mole of water from its polyhydroxy alkyl chain, whereby a cyclic structure is obtained, which has an ether group. Preferred compounds that are obtained from the compound of formula 1 by elimination of one mole of water from its polyhydroxy alkyl chain are compounds according to the formulae (2) to (4)

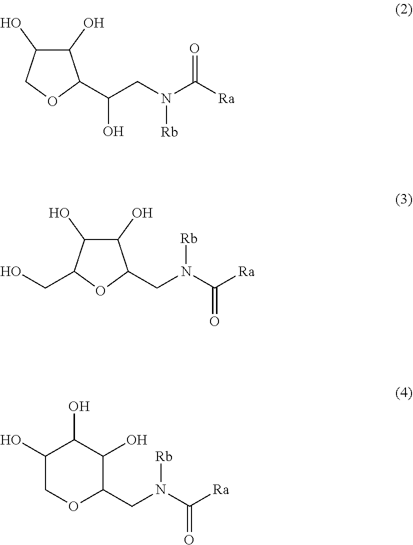

In formulae (2)-(4), Ra and Rb have the meaning as mentioned above.

Ra preferably means a C₇ to C₂₃, more preferably a C₉ to C₂₁, most preferably C₁₁ to C₁₇ aliphatic residue. In another preferred embodiment Ra is either an alkyl or an alkenyl group, preferably an alkyl group. In another preferred embodiment Ra is an alkyl or alkenyl group that is branched.

Rb preferably is an alkyl or alkenyl group. Preferably, Rb has 1 to 5 carbon atoms. Mostly preferred, Rb is methyl.

If the sulfur synergist is a compound according to formula (5)

R¹—S—R² (5)

in one preferred embodiment R¹ is H and R² is an alkyl group with 1 to 12 carbon atoms, i.e. the sulfur synergist is a thiol. R² may also contain oxygen or nitrogen atoms.

In another preferred embodiment, R¹ is alkyl with 1 to 4 carbon atoms and R² is alkyl with 2 to 26 carbon atoms, i.e. the sulfur synergist is a thioether. Both R¹ and R² may also contain oxygen or nitrogen atoms.

In the case where R¹ or R² contains a carboxylic acid group, salts may be formed as follows:
a) with monovalent Li, Na, K, Ag, Cu or NH₄, and tertiary amines with alkyl, alkylene or alkoxyalkyl side groups, that may also be cyclic and may contain the heteroatoms O or N;
b) with bivalent counterions wherein the counterion is selected from the group consisting of Mg, Ca, Sr, Cu, Zn, Pb or Fe and tertiary amines with alkyl, alkylene or alkoxyalkyl side groups, that may also be cyclic and may contain the heteroatoms O or N;
c) with trivalent counterions wherein the counterion is selected from the group consisting of Al, Bi or Fe.

In this embodiment, the expression alkyl means alkyl with 1 to 20 carbon atoms. Alkylene means alkylene with 1 to 20 carbon atoms. Alkoxy means an alkoxy group with 1 to 100 alkoxy groups, preferably 1 to 100 ethoxy or propoxy groups. Alkoxy groups may be pure ethoxy, pure propoxy or mixed.

Such compounds are thioglycolic acid salts if one of R¹ or R² is hydrogen. The use of thioglycolic acid salts is a preferred embodiment of the invention. Another name for thioglycolic acid is mercapto acetic acid.

In another preferred embodiment the sulfur synergist is 2-mercaptoethanol, whose structure is:

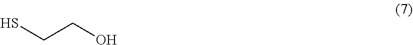

If the sulfur synergist is a thiosulfate it corresponds preferably to a compound according to formula (8)

Mₓ(S₂O₃)_{y} (8)

wherein
x=2 and y=1 and M=Li, Na, K, Ag, Cu or NH₄;
x=1 and y=1 and M=Mg, Ca, Sr, Cu, Zn, Pb or Fe;
x=2 and y=3 and M=Al, Bi or Fe.

In yet another preferred embodiment, ammonium thiosulfate is used, whose structure is:

(NH₄)₂S₂O₃ (9)

In another preferred embodiment the sulfur synergist is thiourea, whose structure is:

S═C(NHR⁵)(NHR⁶) (10)

wherein
R⁵ and R⁶ are preferably alkyl groups with 1 to 4 carbon atoms that may also contain oxygen or nitrogen atoms or aromatic structures with 6 to 12 carbon atoms.

The sulfur synergists are preferably selected from the group consisting of thioglycolic acid, sodium thiosulfate, ammonium thiosulfate, sodium thiosulfate, potassium thiosulfate, thiourea, sodium thioglycolate, ammonium thioglycolate, thiourea and derivatives such as 1,2-diethylthiourea, propylthiourea, 1,1-diphenylthiourea, thiocarbanilide, 1,2-dibutylthiourea or 2-Mercaptoethanol, 3-(Methylthio)propanal, thioacetic acid, cyste-amine, 1-mercapto-2-propanol, 2-Methoxyethane-thiol, 3-Mercapto-1-propanol, 2,3-Dimercapto-1-propanol, 1-Thio-glycerol, mercaptosuccinic acid, Cysteine, N-Carbomoyl-L-cysteine, N-Acetylcysteamine, 4-Mercapto-1-butanol, 1-Butanedithiol, 4-Cyano-1-butanethiol, 2-Methyl-1-butanethiol, 2-Ethylhexane thiol, N-Alkyl and alkenyl-methionine, such as N-Oleyl-methionine and the corresponding carboxylic acid salts (organic- and inorganic based).

In another preferred embodiment, N-Oleyl-Methionine and the corresponding amine salts as described in EP-1979508 can be employed as group b1 sulfur synergist.

The composition to be used according to this invention is suitable as corrosion inhibitors, in particular in petroleum extraction and processing plants which come into contact with salt water.

In the composition to be used according to this invention, the ratio of the glucamide component a) to the sulfur synergist b) is from 100:1 to 1:30 preferably from 30:1 to 1:1 by weight.

Since the compounds to be used according to this invention are usually prepared as highly viscous liquids, they are preferably used as a 10-50% by weight strength solution, for example in water, glycols, glycol ethers, alcohols and other suitable solvents. These solutions can, as an overall formulated composition, also comprise other corrosion-inhibiting active ingredients and also emulsifiers, antifoaming agents and further customary additives which improve the useful properties of the product being applied.

The overall formulated composition as described in the paragraph above is then dosed into the crude oil stream in an amount of 0.2 to 500 ppm, preferably from 1 to 300 ppm, most preferably from 30 to 300 ppm.

One of the advantages of the composition to be used according to this invention is that there is provided at least partly a renewable product-based substance. By adding it to the produced fluids, i.e. oil/water emulsions during oil production, it can provide an enhanced protection against corrosion of the downhole tubulars, processing equipment, pipeline systems and ultimately refineries.

Further advantages of the composition to be used according to this invention is superior corrosion inhibitor performance, particularly at high temperature in high salinity brines saturated with corrosive gases, e.g. CO₂.

The composition works well under heat, pressure, high salinity and high water hardness. A temperature of up to 150° C. is possible. A salinity of up to 300,000 ppm is also possible.

The starting materials of the surfactant systems according to formulae (1) to (4) are inexpensive and renewable. These surfactants are non-toxic, biodegradable and reusable.

In most cases it is not necessary to use organic solvents in formulations comprising compounds (I)-(IV) and the sulfur-based synergist. Water is used as solvent which is advantageous from an economic and from an environmental point of view. Another unique advantage is that the disclosed surfactant does not readily absorb/interact to/with mineral surfaces due to its secondary amide character and the disability to form intermolecular NH hydrogen bonds which reduces the loss of surfactant concentration for instance in a recycled system.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

The term “about” as used in connection with a numerical value throughout the description and the claims denotes an interval of accuracy, familiar and acceptable to a person skilled in the art. Said interval is +/−10%.

“Crude Oil” is used herein to denote a naturally occurring mixture consisting of a complex mixture of hydrocarbons of various molecular weights and other organic compounds that are typically found in geologic formations beneath the Earth's surface.

“Hydrocarbon” is used herein to denote an organic compound comprising hydrogen and carbon.

“Sweet gas” is used herein to denote an extracted natural gas that is found to be free from hydrogen sulfide.

In the embodiments the surfactant comprises a secondary amide of formulae (1)-(4). The secondary amides, in contrast with primary amides, are not able to form intermolecular hydrogen bonds, ensuring potential negative intermolecular interactions that result in liquid crystal, gel formation or poor solubilization properties as well as strong interaction/adsorption with/on metallic pipe surfaces.

In one embodiment of all aspects, the glucamide surfactants described herein are thermally stable up to 150° C. without any degradation. In other words, the glucamide surfactants are potentially applicable at reservoir and process temperatures up to 150° C. but also is dependent upon salinity and in general produced water and oil chemistry.

Most of the commercially available corrosion inhibitor systems for these applications are either toxic, multi-component systems that are not tolerant to both high salinity and high temperatures, or have been formulated with components that only provide limited functionality, when compared to the current high performance embodiments of the instant invention. Additionally, the commercially available treating solution is of limited inhibition efficiency especially if environmental acceptability is a requirement. Another problem related to the prior art systems is that the kinetics of functionality are slow, the time to achieve maximum inhibition efficiency can take several hours due to interactions between the components of the prior art corrosion inhibitor packages and the high temperature hard brine itself.

The composition to be used according to this invention is added to the oil/water system or injected into the application to provide corrosion protection. The injection fluid may additionally contain other ingredients known to those familiar with the art, including but not restricted to acids, dispersants, viscosifiers, lubricity agents, scale inhibitors, friction reducers, crosslinkers, surfactants, scavenger pH adjusters, iron control agents, breakers; this is especially true if any produced water (or recycled water) is used to perform the treatment.

Employing the embodiments of the instant invention improves nullification of the oil/water to render it benign and non-corrosive and damaging to the integrity of the metallurgy and equipment it will be used to treat, thus allowing better integrity management and control and corrosion inhibition protection. Other applications of the embodiments of the instantaneous invention include treating water for downhole injection for pressure support, treatment of water for drilling and work-over use, wettability alteration and well cleanout.

Other features and uses of the invention and their associated advantages will be evident to a skilled person in the art upon reading the description and the examples.

### EXAMPLES

If not stated otherwise, references to % or ppm mean weight-% or weight-ppm throughout this specification.

The following abbreviations to substances have been used in this section:

The samples and the results are summarized below:

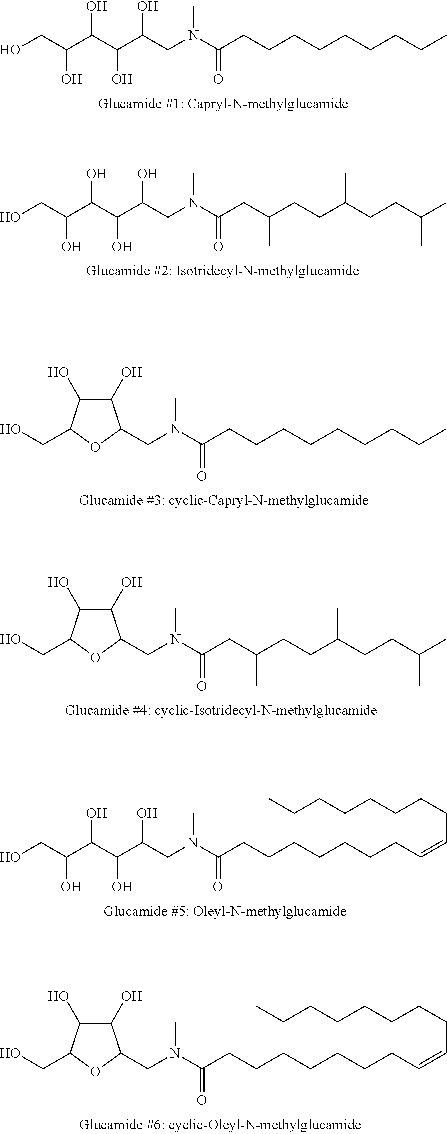 [SMILES: CCCCCCCCCC(=O)N(C)CC(O)C(O)C(O)C(O)CO ; CC(C)CCC(C)CCC(C)CC(=O)N(C)CC(O)C(O)C(O)C(O)CO ; CCCCCCCCCC(=O)N(C)CC1OC(CO)C(O)C1O ; CC(C)CCC(C)CCC(C)CC(=O)N(C)CC1OC(CO)C(O)C1O ; CCCCCCCC/C=C\CCCCCCCC(=O)N(C)CC(O)C(O)C(O)C(O)CO ; CCCCCCCC/C=C\CCCCCCCC(=O)N(C)CC1OC(CO)C(O)C1O]

### Abbreviations

ATG: Ammonium Thioglycolate (thiol)/b1
TG-TEA: Thioglycolate salt with triethanolamine (thiol)/b1
MET: Mercaptoethanol (thiol)/b1

### ATS: Ammoniumthiosulfate (Thiosulfate)/b2

OMet: N-Oleyl-Methionine (thioether)/b1
OMet-TEA: N-Oleyl Methionine salt with triethanolamine (thioether)/b1

### TU: Thiourea/b3

AS: Ammonium sulfate
IAA: Isoascorbic acid
TM: Test material/glucamide
Ref: Reference (sodium benzoate) in OECD 306 test
mpy: mill-inch per year

Firstly the environmental data were determined according to OECD 306 biodegradability and aquatic toxicity testing on the glucamides and the result is outlined in Tables 1 and 2.

TABLE 1
OECD 306 biodegradation of additives and
aquatic toxicity testing of Glucamide #1

Day [%]

| No. | | 7 | 14 | 21 | 28 |
|---|---|---|---|---|---|
| 1.1 | Glucamide #1 | 15 | 25 | 33 | 31 |
| 1.2 | MET | 5 | 6 | 8 | 17 |
| 1.3 | ATG | 9 | 20 | 33 | 39 |
| 1.4 | OMet | 60 | 60 | 60 | 60 |
| 1.5 | TU | 19 | 32 | 20 | 55 |
| 1.6 | Reference | 78 | 74 | 86 | 68 |

| | | | Range-finding | Definitive |
|---|---|---|---|---|
| No. | Aquatic Toxicity | Test | result [mg/l] | result [mg/l] |
| 1.7 | Glucamide # 1 | 72 hr | 335.40 | 165.24 |
| | | Algae EC₅₀ | | |

TABLE 2
Marine BODIS and aquatic toxicity testing of Glucamide #5

| | | ThOD | Addition rate | Day [%] | | | |
|---|---|---|---|---|---|---|---|
| No. | | [mgO₂/mg] | [mg/bottle] | 7 | 14 | 21 | 28 |
| 2.1 | Glucamide # 5 | 2.056 | 4.864 | 23 | 33 | 37 | 42 |
| 2.2 | TM + Ref | — | — | 45 | 52 | 57 | 64 |
| 2.3 | Reference | 1.60 | 12.00 | 66 | 77 | 81 | 83 |

| | | | Range-finding | Definitive |
|---|---|---|---|---|
| No. | Aquatic Toxicity | Test | result [mg/l] | result [mg/l] |
| 2.4 | Glucamide # 5 | 72 hr | 6.199 | 4.55 |
| | | Algae EC₅₀ | | |

The OECD 306 test is disclosed in the April 2005 version of the OECD guideline for testing of chemicals. The results clearly show the positive results for biodegradation and toxicity of the glucamides and the Sulphur synergists described in this application. A test for ATG was not conducted as this is an inorganic salt.

In order to evaluate the corrosion inhibition efficacy of the formulations, two different test methods were employed: rotating cylinder electrode (RCE) tests and high pressure, high temperature (HPHT) autoclave weight loss tests. For all testing, the following standard brine composition was used (as outlined in table 3):

TABLE 3
Synthetic brine composition for corrosion testing

| Ionic Species | Ionic Concentration [mg/l] |
|---|---|
| Sodium (Na⁺) | 914.87 |
| Potassium (K⁺) | 32.93 |
| Magnesium (Mg²⁺) | 110.24 |
| Calcium (Ca²⁺) | 34.68 |
| Strontium (Sr²⁺) | 1.15 |
| Chloride (Cl⁻) | 1644.95 |
| Bicarbonate (HCO₃⁻) | 12.11 |
| Sulfate (SO₄²⁻) | 229.58 |

A gas composition of 100% CO₂ was used throughout testing.

The metallurgy of the coupons tested was C1018 carbon steel for RCE testing and HPHT autoclave testing. Coupons were polished mechanically using 320 grit silicon-carbide (SiC) paper, 400 grit SiC paper, then 600 grit SIC paper and rinsed with water then acetone prior to testing.

The rotating cylinder electrode (RCE) tests were conducted in Pyrex™ glass reaction kettles that were heated to 150° F. The testing solution was comprised of 900 mL of brine. The electrode rotation rate was set at 2000 RPM, which generated a wall shear stress of 7.0 Pa. Linear polarization resistance (LPR) measurements were made with a Gamry electrochemical measurement system. The working electrode was made of a 1018 carbon steel (CS) cylinder with a surface area of 3.16 cm². A Hastelloy C276 electrode was used as a pseudo-reference, and a titanium rod was used as the counter electrode. The corrosion inhibitors were added based on the brine volume after the baseline corrosion rate was monitored for approximately 1.5 hours. The baseline corrosion rate corresponds to the blank corrosion value. Upon completion of the tests, the electrodes were cleaned in an inhibited acid bath according to ASTM G1 C.3.5, and weighed to 0.1 mg.

High pressure, high temperature (HPHT) rotating cage autoclave (RCA) tests were used to simulate more realistic and extreme conditions for the purpose of evaluating system corrosivity as well as inhibitor performance. The test solution consisted of 800 mL of brine. The brine was deoxygenated using 100% carbon dioxide gas before final pressurization into the autoclaves. Three weight loss corrosion coupons fixed on a PEEK (Polyether ether ketone) insulated cage were used in each autoclave. General corrosion rates were calculated by weight loss measurement according to ASTM G170 (and associated standards referenced therein). Test conditions were constant in all examples with a temperature of 66 and 149° C. at a constant pressure of 34.5 bar, the inhibitors were dosed in at a variety of dose rates ranging from 150 to 300 ppm (based on each inhibitor component) and the tests were run for 3 to 6 days.

The surfaces of the electrodes and coupons were analyzed after each test for pitting potential by using a high powered metallurgical microscope. The reflected light microscope was capable of analyzing samples up to 1,000-times magnification. The microscope was mounted with a camera and included brightfield, darkfleld, and Differential Interface Controls (DIC) modes.

TABLE 4
Corrosion test (RCE)

| | | Sugar | Sulfur-based | Corrosion Rate [mpy] | | | Protection [%] | |
|---|---|---|---|---|---|---|---|---|
| | | derivative | derivative | 2 hr | 2 hr after | Final | 2 hr after | Final |
| No. | Example kind | [ppm] | [ppm] | baseline | Cl dose | 3 hr | Cl dose | 3 hr |
| 4.1 | Comparative 1 | Glucamide #1 (12) | None | 158.4 | 44.2 | 11.6 | 72.1 | 92.7 |
| 4.2 | Comparative 2 | Glucamide #2 (12) | None | 165.7 | 34.6 | 10.2 | 79.1 | 93.8 |
| 4.3 | Comparative 3 | Glucamide #3 (12) | None | 168.2 | 44.8 | 10.9 | 73.4 | 93.5 |
| 4.4 | Comparative 4 | Glucamide #4 (12) | None | 173.4 | 41.6 | 9.8 | 76.0 | 94.3 |
| 4.5 | Comparative 5 | Glucamide #5 (12) | None | 159.1 | 38.6 | 9.6 | 75.7 | 94.0 |
| 4.6 | Comparative 6 | Glucamide #6 (12) | None | 181.7 | 42.4 | 10.6 | 76.7 | 94.2 |
| 4.7 | Comparative 7 | None | ATG (12) | 168.6 | 47.6 | 14.5 | 71.8 | 91.4 |
| 4.8 | Comparative 8 | None | MET (12) | 178.3 | 45.6 | 15.4 | 74.4 | 91.4 |
| 4.9 | Comparative 9 | None | ATS (12) | 158.5 | 38.7 | 13.9 | 75.6 | 91.2 |
| 4.10 | Comparative 10 | None | OMet (12) | 176.9 | 39.6 | 12.9 | 77.6 | 92.7 |
| 4.11 | Comparative 11 | None | TU (12) | 158.1 | 38.5 | 10.9 | 75.6 | 93.1 |
| 4.12 | Comparative 12 | Imidazoline acetate - | None | 172.6 | 72.3 | 21.6 | 58.1 | 87.5 |
| | | 12 ppm Commercial | | | | | | |
| | | Product A | | | | | | |
| 4.13 | Inventive 1 | Glucamide #1 (10) | ATG (2) | 168.2 | 32.6 | 5.4 | 80.6 | 96.2 |
| 4.14 | Inventive 2 | Glucamide #1 (11) | ATG (1) | 176.8 | 30.9 | 5.5 | 82.5 | 96.9 |
| 4.15 | Inventive 3 | Glucamide #1 (10) | MET (2) | 182.6 | 36.6 | 4.3 | 80.0 | 97.6 |
| 4.16 | Inventive 4 | Glucamide #1 (10) | ATS (2) | 156.9 | 28.6 | 3.4 | 81.8 | 97.8 |
| 4.17 | Comparative 13 | IAA (10) | ATS (2) | 176.1 | 60.9 | 17.6 | 65.4 | 90.0 |
| 4.18 | Comparative 14 | Glucamide #1 (10) | AS (2) | 165.9 | 50.6 | 15.9 | 69.5 | 90.4 |
| 4.19 | Inventive 5 | Glucamide #1 (10) | OMET (2) | 184.3 | 38.1 | 5.7 | 79.3 | 96.9 |
| 4.20 | Inventive 6 | Glucamide #1 (10) | OMET (1), ATG (1) | 176.5 | 32.6 | 4.8 | 81.5 | 97.3 |
| 4.21 | Inventive 7 | Glucamide #1 (10) | TG-TEA (2) | 156.8 | 30.0 | 3.2 | 80.9 | 98.0 |
| 4.22 | Inventive 8 | Glucamide #1 (10) | OMet-TEA (2) | 166.7 | 29.1 | 4.0 | 82.5 | 97.6 |
| 4.23 | Inventive 9 | Glucamide #1 (10) | TU (2) | 178.7 | 29.3 | 5.0 | 83.6 | 97.2 |

The HPHT RCA results are displayed in Table 5 in which a comparison is made for the following conditions:

1. 66° C., 34.5 bar, 700 rpm, 3 days

2. 149° C., 27.6 bar, 700 rpm, 5 days

TABLE 5
HPHT RCA testing results at 66° C. and 149° C.

| | | | | Average | Average |
|---|---|---|---|---|---|
| | | | | Corrosion Rate | Corrosion Rate |
| | | Glucamide | Sulphur synergist | [mpy] | [mpy] |
| No. | Product | (amount in ppm) | (amount in ppm) | At 66° C. | At 149° C. |
| 5.1 | Blank | | | 321.37 | 434.85 |
| 5.2 | Comparative 1 | Glucamide #1 (150) | None | 6.25 | 41.90 |
| 5.3 | Comparative 2 | Glucamide #2 (150) | None | 4.23 | 35.66 |
| 5.4 | Comparative 3 | Glucamide #3 (150) | None | 4.81 | 36.10 |
| 5.5 | Comparative 4 | Glucamide #4 (150) | None | 3.62 | 29.73 |
| 5.6 | Comparative 5 | Glucamide #5 (150) | None | 3.87 | 32.76 |
| 5.7 | Comparative 6 | Glucamide #6 (150) | None | 3.92 | 35.79 |
| 5.8 | Comparative 7 | None | ATG (150) | 6.32 | 40.61 |
| 5.9 | Comparative 8 | None | MET (150) | 5.21 | 38.12 |
| 5.10 | Comparative 9 | None | ATS (150) | 4.89 | 34.87 |
| 5.11 | Comparative 10 | None | OMet (150) | 7.89 | 44.45 |
| 5.12 | Comparative 11 | None | TU (150) | 6.02 | 42.09 |
| 5.13 | Comparative 12 | Imidazoline acetate - | None | 11.24 | 76.20 |
| | | 150 ppm Commercial | | | |
| | | Product A | | | |
| 5.14 | Inventive 1 | Glucamide #1 (75) | ATG (75) | 2.74 | 20.8 |
| 5.15 | Inventive 2 | Glucamide #1 (120) | ATG (30) | 1.89 | 21.7 |
| 5.16 | Inventive 3 | Glucamide #1 (75) | MET (75) | 2.24 | 22.8 |
| 5.17 | Inventive 4 | Glucamide #1 (75) | ATS (75) | 2.65 | 24.1 |
| 5.18 | Comparative 13 | IAA (75) | ATS (75) | 7.53 | 46.3 |
| 5.19 | Comparative 14 | Glucamide #1 (75) | AS (75) | 6.79 | 45.2 |
| 5.20 | Inventive 5 | Glucamide #1 (75) | OMET (75) | 2.55 | 22.9 |
| 5.21 | Inventive 6 | Glucamide #1 (100) | OMET (20), ATG (30) | 2.31 | 25.0 |
| 5.22 | Inventive 7 | Glucamide #1 (75) | TG-TEA 75) | 2.03 | 26.6 |
| 5.23 | Inventive 8 | Glucamide #1 (75) | OMet-TEA (75) | 2.11 | 23.6 |
| 5.24 | Inventive 9 | Glucamide #1 (75) | TU (75) | 2.41 | 21.9 |

Comparative examples 1 to 6 show the results of the various glucamides 1 to 6, which already show encouraging results as described in DE-102014003367. Comparative examples 7 to 11 show the results for the Sulphur based materials only. As a comparison to the glucamides only, comparative example 12 shows the results obtained when using imidazole acetate as a reference sample, which shows much worse results. Inventive examples 1-9 describe the use of a thiol, thio ether, thioacetic acid (as inorganic or organic salt), N-Oleyl-methionine (free acid or organic salt), thiourea or thiosulfate, which show a dramatic increase in performance over the glucamides or Sulphur-based materials only and a synergistic effect when using these sulfur-based derivatives, or combinations thereof. Comparative example 13, shows the effect of replacement of the glucamide by Isoascorbic acid analogous as described in U.S. Pat. Nos. 4,784,778 and 4,784,779 and shows the beneficial effect of the glucamide. The use of a sulfate as described in comparative example 14 (to DE-102014003367) shows that a normal sulfate does not help in corrosion inhibition.

Surprisingly, it was found that the use of the combination of a glucamide and at least one sulfur-based synergist showed the best effects in corrosion inhibition.

1. A composition comprising
a) at least one compound according to formula (1) 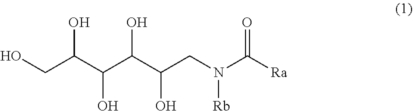
wherein
Ra is a C₅ to C₂₉ linear, branched, saturated or unsaturated aliphatic hydrocarbon group,
Rb is a C₁ to C₂₃ linear, branched, saturated or unsaturated aliphatic hydrocarbon group,
or a compound obtainable from formula 1 by eliminating one mole of water from the polyhydroxy group, thereby forming a cyclic ether, and
b) at least one sulfur synergist selected from the group consisting of
b1) a compound according to formula (5)
R¹—S—R² (5)
wherein
R¹ and R² are independently hydrogen, C₁ to C₁₈ alkyl, C₂ to C₁₈ alkenyl or a C₇ to C₁₈ alkyl aromatic group, and wherein R¹ and R² may contain oxygen or nitrogen atoms, or may be substituted with a carboxylic acid group or an amide group, with the proviso that R¹ and R² are not both hydrogen
b2) a metal or ammonium thiosulfate salt, and
b3) a compound according to formula (6)
S=C(NHR⁵)(NHR⁶) (6)
wherein
R⁵ and/or R⁶ are H, C₁ to C₁₀ alkyl, C₂ to C₁₀ alkenyl or C₅ to C₉ aryl groups or mixtures thereof, as a corrosion inhibitor for metallic oilfield equipment.

2.-14. (canceled)

15. A process for preventing corrosion on metallic oilfield equipment, comprising the step of adding a composition comprising
a) at least one compound according to formula (1) 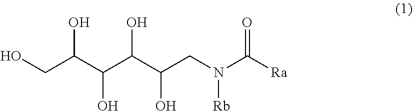
wherein
Ra is a C₅ to C₂₉ linear, branched, saturated or unsaturated aliphatic hydrocarbon group,
Rb is a C₁ to C₂₃ linear, branched, saturated or unsaturated aliphatic hydrocarbon group,
or a compound obtainable from formula 1 by eliminating one mole of water from the polyhydroxy group, thereby forming a cyclic ether, and
b) at least one sulfur synergist selected from the group consisting of
b1) a compound according to formula (5)
R¹—S—R² (5)
wherein
R¹ and R² are independently hydrogen, C₁ to C₁₈ alkyl, C₂ to C₁₈ alkenyl or a C₇ to C₁₈ alkyl aromatic group, and wherein R¹ and R² may contain oxygen or nitrogen atoms, or may be substituted with a carboxylic acid group or an amide group, with the proviso that R¹ and R² are not both hydrogen
b2) a metal or ammonium thiosulfate salt, and
b3) a compound according to formula (6)
S=C(NHR⁵)(NHR⁶) (6)
wherein
R⁵ and/or R⁶ are H, C₁ to C₁₀ alkyl, C₂ to C₁₀ alkenyl or C₅ to C₉ aryl groups or mixtures thereof, to a fluid produced from an oil or gas well, the fluid being in contact with the metallic oilfield equipment.

16. The process according to claim 15, wherein component a) is obtained from the compound of formula 1 by elimination of one mole of water from its polyhydroxy alkyl chain, and is a compound according to the formulae (2) to (4) 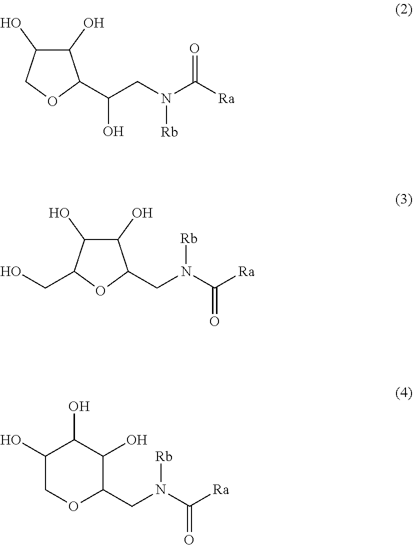
wherein
Ra is a C₅ to C₂₉ linear, branched, saturated or unsaturated aliphatic hydrocarbon group,
Rb is a C₁ to C₂₃ linear, branched, saturated or unsaturated aliphatic hydrocarbon group.

17. The process according to claim 15, in which Ra is an alkyl or alkenyl group with 7 to 21 carbon atoms.

18. The process according to claim 15, in which Rb is methyl.

19. The process according to claim 15, in which the sulfur synergist is represented by the formula R¹—S—R² wherein R¹ is hydrogen, and R² is an alkyl group with 1 to 12 carbon atoms that may contain oxygen or nitrogen atoms.

20. The process according to claim 15, in which the sulfur synergist is represented by the formula R¹—S—R² wherein
R¹ is an alkyl group having 1 to 4 carbon atoms, that may contain oxygen or nitrogen atoms and
R² is an alkyl group having 2 to 26 carbon atoms, that may contain oxygen or nitrogen atoms

21. The process according to claim 15, wherein one of R¹ and R² comprises a carboxylic acid group.

22. The process according to claim 21, in which the sulfur synergist is represented by the formula M(HSCH₂COO)ₓ wherein
a) x=1 and M is selected from the group consisting of Li, Na, K, Ag, Cu or NH₄, and tertiary amines with alkyl, alkylene or alkoxyalkyl side groups, that may also be cyclic and may contain the heteroatoms O or N;
b) x=2 and M is selected from the group consisting of Mg, Ca, Sr, Cu, Zn, Pb or Fe and tertiary amines with alkyl, alkylene or alkoxyalkyl side groups, that may also be cyclic and may contain the heteroatoms O or N;
c) x=3 and M is selected from the group consisting of Al, Bi or Fe.

23. The process according to claim 15, in which the sulfur synergist is, represented by the formula Mₓ(S₂O₃) wherein
x=2 and y=1 and M=Li, Na, K, Ag, Cu or NH₄; or
x=1 and y=1 and M=Mg, Ca, Sr, Cu, Zn, Pb or Fe; or
x=2 and y=3 and M=Al, Bi or Fe.

24. The process according to claim 15, in which the sulfur synergist is a thiourea, represented by the formula
S=C(NHR⁵)(NHR⁶) (6)
wherein
R⁵ and/or R⁶ are H, C₁ to C₁₀ alkyl, C₂ to C₁₀ alkenyl or C₅ to C₉ aryl groups or mixtures thereof.

25. The process according to claim 15, wherein the concentration of component a) is from 0.1 to 30 ppm.

26. The process according to claim 15, wherein the concentration of component b) is from 0.1 to 10 ppm.

27. The process according to claim 15, wherein the ratio of the glucamide component a) to the sulfur synergist b) is from 100:1 to 1:30 preferably from 30:1 to 1:1 by weight.

28. The process according to claim 15, wherein the concentration of the composition according to claims 1 to 13 is from 0.2 to 40 wt.-ppm.
